(19) United States
(12) Patent Application Publication
(10) Pub. No.: US 2025/0115190 A1
(43) Pub. Date: Apr. 10, 2025

(54) POWER-SLIDE VEHICLE COMPARTMENTS

(71) Applicant: Tesla, Inc., Austin, TX (US)

(72) Inventors: Raghav Jalan, Austin, TX (US); Aneesh Kaliyanda, San Jose, CA (US); Harold Mejia Ruiz, Austin, TX (US); Shakeel Theodore, Fremont, CA (US); Alessandro Bernardis Valenzuela, Austin, TX (US); Karun Balachandran, Hayward, CA (US)

(21) Appl. No.: 18/832,313

(22) PCT Filed: Dec. 8, 2022
(86) PCT No.: PCT/US2022/052284

§ 371 Date: Jul. 23, 2024

Related U.S. Application Data
(60) Provisional application No. 63/302,336, filed on Jan. 24, 2022.

(51) Int. Cl. B60R 7/06; B60R 11/00

(52) U.S. Cl. CPC B60R 7/06; B60R 2011/0005; B60R 2011/0084; B60R 2011/0092

(57) ABSTRACT

A vehicle storage assembly (12) is provided that includes a compartment housing (20) having an opening and a compartment (22) proximate to the opening and configured to move between an open configuration and a closed configuration. A controller (36) can receive an input signal and automate movement of the compartment (22) between the open configuration and the closed configuration. An activation and latch mechanism (14) allows a user to manually move the compartment to the closed configuration. The manual movement of the compartment by the user towards the closed configuration latches the compartment (22) in a latch position when the compartment (22) reaches the closed configuration.

### CROSS-REFERENCE TO RELATED APPLICATIONS

This application claims the benefit of U.S. Provisional Application No. 63/302,336, filed Jan. 24, 2022, the entire disclosure of which is hereby incorporated by reference in its entirety.

### TECHNICAL FIELD

This application relates to vehicle storage compartments, and more particularly relates to a storage compartment assembly that automates movement of a compartment on a vehicle while also allowing a user to manually close the compartment.

### BACKGROUND

Generally described, a variety of vehicles, such as electric vehicles, combustion engine vehicles, hybrid vehicles, etc., can be configured with one or more storage compartments. These compartments can store vehicle accessories, personal belongings and other objects. For example, vehicles typically include a glove box usually located in the dash on the front passenger side of the passenger compartment. The glove box can include a compartment that slides between open and closed configurations. The glove box can have an automation mechanism and a latch mechanism. The automation mechanism can move the compartment between the open and closed configurations while the latch mechanism locks the compartment when in the closed configuration. However, requiring both the automation mechanism and the latch mechanism results in higher cost, mass, number of components, and complexity to the vehicle storage compartment reducing reliability of the system.

### SUMMARY

An aspect is directed to a vehicle storage assembly that includes a compartment housing having an opening and a compartment proximate to the opening and configured to move between an open configuration and a closed configuration. A controller is configured to receive an input signal and automate movement of the compartment between the open configuration and the closed configuration. The vehicle storage system further includes an activation and latch mechanism coupled to the compartment and configured for a user to manually move the compartment to the closed configuration. The manual movement of the compartment by the user towards the closed configuration latches the compartment in a latch position when the compartment reaches the closed configuration.

A variation of the aspect above is, wherein the input signal is received from one or more of a display, a key fob, a button, and a switch.

A variation of the aspect above is, wherein the compartment is configured as a drawer of a glove box.

A variation of the aspect above is, wherein the compartment housing is sized and shaped to receive the drawer of the glove box.

A variation of the aspect above is, wherein the automated movement is linear movement of the compartment relative to the compartment housing.

A variation of the aspect above is, wherein the manual movement is linear movement of the compartment relative to the compartment housing.

A variation of the aspect above is, wherein the activation and latch mechanism comprises an arm and a gear, and wherein the arm couples the compartment to the gear.

A variation of the aspect above is, wherein the arm converts linear motion of the compartment caused by the user manually moving the compartment towards the closed configuration to rotational motion of the gear.

A variation of the aspect above further comprises a motor configured to cause the automated movement of the compartment between the open configuration and the closed configuration.

A variation of the aspect above further comprises a pinion coupled to the gear and the motor.

A variation of the aspect above is, wherein the latch position occurs when the arm is oriented so as be collinear with a direction of the manual movement and the compartment is in the closed configuration.

A variation of the aspect above is, wherein when the compartment is in the latch position, the activation and latch mechanism prevents the user from manually moving the compartment to the open configuration.

A variation of the aspect above is, wherein when the compartment is in the latch position, the activation and latch mechanism allows the controller to automate movement of the compartment to the open configuration.

A variation of the aspect above further comprises a display configured to receive the input signal, the compartment moving between the open configuration and the closed configuration in response at least in part to the input signal.

A variation of the aspect above is, wherein the input signal is a screen tap on the display.

A variation of the aspect above is, wherein the display is disposed remote from the activation and latch mechanism.

A variation of the aspect above is, wherein the compartment housing comprises a door, and wherein the door is a trim panel.

A variation of the aspect above is, wherein the compartment is disposed behind the trim panel at least when in the closed configuration.

A variation of the aspect above is, wherein the compartment is configured as a center console lid.

A variation of the aspect above is, wherein the compartment is configured as a trunk tub cover.

A variation of the aspect above is, wherein the compartment is configured as a drawer of a truck bed storage box.

A variation of the aspect above is, wherein the compartment is configured as a drawer of a cargo hauling system configured for mounting to a vehicle.

A variation of the aspect above is, wherein the compartment is configured to be located within a passenger compartment of a vehicle.

A variation of the aspect above is, wherein the compartment is configured to be located outside of a passenger compartment of a vehicle.

An aspect is directed to an activation and latch mechanism for a vehicle that allows automated movement of a compartment between an open configuration and a closed configuration while also allowing manual movement of the compartment from the open configuration towards the closed configuration and preventing the manual movement of the compartment from the closed configuration towards the open configuration. The compartment is in a latch position when the compartment reaches the closed configuration.

A variation of the aspect above is, wherein the compartment is configured as a drawer of a glove box.

A variation of the aspect above further comprises a compartment housing sized and shaped to receive the drawer of the glove box.

A variation of the aspect above is, wherein the automated movement is linear movement of the compartment.

A variation of the aspect above is, wherein the manual movement is linear movement of the compartment.

A variation of the aspect above further comprises an arm and a gear, wherein the arm couples the compartment to the gear.

A variation of the aspect above is, wherein the arm converts linear motion of the compartment to rotational motion of the gear.

A variation of the aspect above further comprises a motor configured to cause the automated movement of the compartment between the open configuration and the closed configuration.

A variation of the aspect above is further comprises a pinion coupled to the gear.

A variation of the aspect above is, wherein the latch position occurs when the arm is oriented so as be collinear with a direction of the manual movement and the compartment is in the closed configuration.

An aspect is directed to a vehicle comprising a compartment housing having an opening, a compartment proximate to the opening and configured to move between an open configuration and a closed configuration, a controller configured to receive an input signal and automate movement of the compartment between the open configuration and the closed configuration, and an activation and latch mechanism coupled to the compartment and configured for a user to manually move the compartment to the closed configuration, wherein the manual movement of the compartment by the user towards the closed configuration latches the compartment in a latch position when the compartment reaches the closed configuration.

A variation of the aspect above is, wherein the compartment housing comprises a door, and wherein the door is a trim panel.

A variation of the aspect above is, wherein the compartment is disposed behind the trim panel at least when in the closed configuration.

A variation of the aspect above is, wherein the compartment is configured as a center console lid.

A variation of the aspect above is, wherein the compartment is configured as a trunk tub cover.

A variation of the aspect above is, wherein the compartment is configured as a drawer of a truck bed storage box.

A variation of the aspect above is, wherein the compartment is configured as a drawer of a cargo hauling system configured for mounting to the vehicle.

A variation of the aspect above is, wherein the compartment is configured to be located within a passenger compartment of the vehicle.

A variation of the aspect above is, wherein the compartment is configured to be located outside of a passenger compartment of the vehicle.

An aspect is directed to a method of closing a compartment housing having an opening, a compartment being proximate to the opening and movable between an open configuration and a closed configuration. The method comprises receiving an input signal to automate movement of the compartment between the closed configuration and the open configuration, moving the compartment by automation to the open configuration based on the input signal, and manually moving the compartment from the open configuration to the closed configuration so as to latch the compartment in the closed configuration.

A variation of the aspect above is, wherein the compartment is configured as a glove box of a vehicle.

A variation of the aspect above is, wherein the compartment is configured as center console lid.

A variation of the aspect above is, wherein the compartment is configured as a trunk tub cover.

A variation of the aspect above is, wherein the compartment is configured as a drawer of a truck bed storage box.

A variation of the aspect above is, wherein the compartment is configured as a drawer of a cargo hauling system configured for mounting to a vehicle.

### BRIEF DESCRIPTION OF THE DRAWINGS

The present inventions are described with reference to the accompanying drawings, in which like reference characters reference like elements, and wherein:

FIG. 1 is an exemplary illustration of an interior of a vehicle that includes a vehicle storage assembly in a passenger compartment and that includes an activation and latch mechanism according to an embodiment.

FIG. 2A is a perspective view of the vehicle storage assembly from FIG. 1.

FIG. 2B is a perspective view of a compartment from the vehicle storage assembly from FIG. 2A.

FIG. 3 is a plan view that includes the activation and latch mechanism from FIG. 2A.

FIG. 4 is a schematic view of the vehicle storage assembly from FIG. 2A that provides both manual activation and automatic activation of the compartment from FIG. 2B.

FIG. 5 is a bottom view of the vehicle storage system from FIG. 2A showing the activation and latch mechanism.

FIG. 6A is a front perspective view of the vehicle storage assembly from FIG. 2A with the compartment linearly slid out of a compartment housing into an open configuration.

FIG. 6B is a side view of the vehicle storage assembly from FIG. 2A with the compartment linearly slid out of the compartment housing into the open configuration.

FIG. 7 is a bottom view of the vehicle storage assembly with an arm of the activation and latch mechanism in a first position opening the compartment.

FIG. 8 shows the arm and gear from FIG. 7 when the arm is in the first position.

FIG. 9 is similar to FIG. 7 except the arm has moved to a second position partially closing the compartment.

FIG. 10 shows the arm and gear from FIG. 9 when the arm is in the second position.

FIG. 11 is similar to FIG. 9 except the arm has moved to a third position closing the compartment in a latch position.

FIG. 12 shows the arm and gear from FIG. 11 when the arm is in the third position inhibiting the compartment from being manually opened.

FIG. 13A is a bottom view of the vehicle storage assembly with the arm of the activation and latch mechanism in the first position opening the compartment.

FIG. 13B is similar to FIG. 13A except the arm has moved to the second position partially closing the compartment.

FIG. 13C is similar to FIG. 13B except the arm has moved to the third position closing the compartment in the latch position.

FIG. 14A is a bottom view of the vehicle storage assembly with the arm in the third position closing the compartment in the latch position. An isolated view of the arm and gear is also illustrated.

FIG. 14B is similar to FIG. 14A except the arm has moved to the second position partially opening the compartment.

FIG. 14C is similar to FIG. 14B except the arm of the activation and latch mechanism has moved to the first position opening the compartment.

FIG. 15 is a plan view that includes the gear and pinion from FIG. 3.

FIG. 16 illustrates how a moment arm for applying a force to open the compartment varies depending on a crank angle of the arm.

FIG. 17 illustrates exemplary values for the force required to open the compartment depending on the angle of the arm from FIG. 16.

### DETAILED DESCRIPTION

Generally described, one or more aspects of the present disclosure relate to interior trim compartments including, for example, an activation and latch mechanism used to automate opening and closing as well as latching of the compartment. In certain embodiments, the activation and latch mechanism decouples latching ability and maximizes user experience by providing both automated and manual usability. The activation and latch mechanism can be employed with any vehicle sliding compartment that requires to be latched (e.g., satisfy safety standards).

For ease of explanation, the compartment housing will be referred to as a static part and the compartment that moves will be referred to as a moving part. In certain embodiments, the activation and latch mechanism is dynamic and involves moving parts. For example, in certain embodiments, the activation and latch mechanism comprises at least an arm which couples a gear to the compartment so that the arm moves the compartment between the open and closed configurations.

In certain embodiments, a glove box is automated to linearly slide by a motor powering the activation and latch mechanism. The activation and latch mechanism allows a user the ability to manually push-to-close the glovebox or automate the glove box movements, therefore maximizing user experience. In certain embodiments, the arm of the activation and latch mechanism is oriented so as be collinear with a direction of movement for the compartment when the compartment is in the closed configuration which latches the compartment in the closed configuration. In this way, in certain embodiments, the arm inhibits or prevents opening of the compartment meeting the safety requirements for Federal Motor Vehicle Safety Standard 206: Door locks and door retention components and SAE J839B: Passenger Car Side Door Latch System.

Certain embodiments may also have lower overall mass, smaller packaging volume, simpler control strategy, lower component count, and fewer NVH/BSR risks, which can all contribute to a more positive user experience as compared to known automation mechanisms and latch mechanisms.

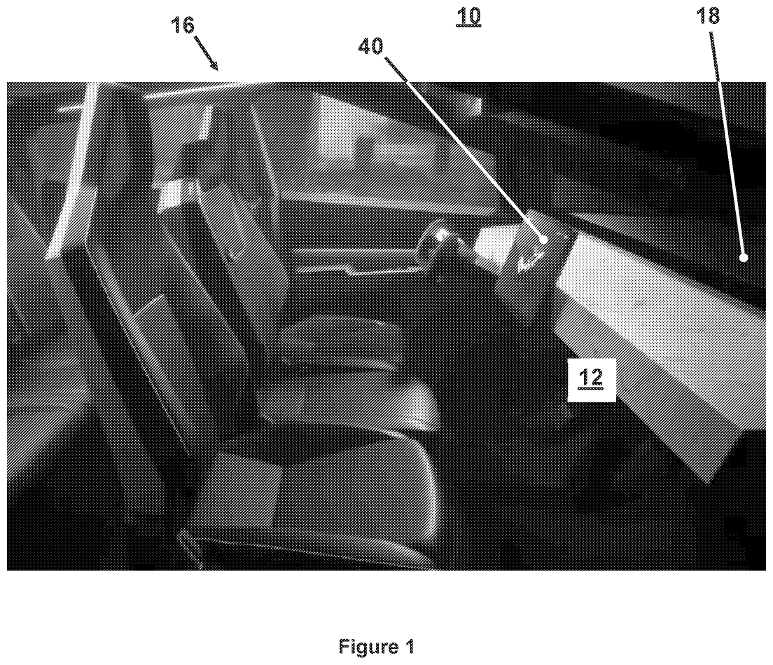

FIG. 1 is an exemplary illustration of an interior of a vehicle 10 that includes a vehicle storage assembly 12 in a passenger compartment 16. In certain embodiments, the vehicle storage assembly 12 comprises an activation and latch mechanism 14. Depending on the configuration, the activation and latch mechanism 14 can move (e.g., slide, pivot, etc.) and latch a compartment 22 (e.g., glovebox, center console lid, trunk tub cover, truck bed storage box, cargo hauling system). The vehicle storage compartment 16 can be mounted inside the passenger compartment 16 or outside of the passenger compartment 16. For example, an embodiment of the vehicle storage compartment 16 can be mounted in the truck bed (e.g., a truck bed storage drawer or box) or as part of a cargo hauling system dimensioned to fit within the bed of the truck.

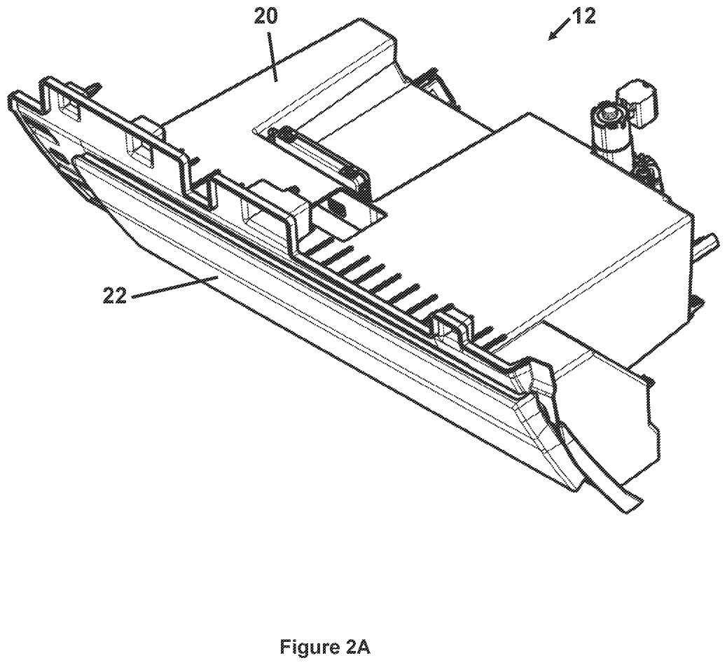

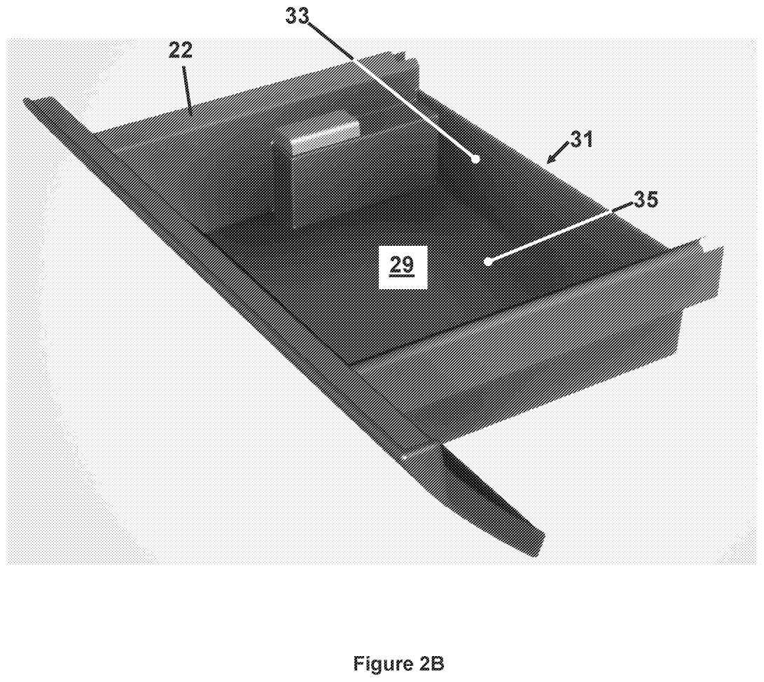

FIG. 2A is a perspective view of the vehicle storage assembly 12 from FIG. 1. FIG. 2B is a perspective view of the compartment 22 from the vehicle storage assembly 12 from FIG. 2A. The vehicle storage assembly 12 can be disposed within a dash 18 of the vehicle 10. The dash 18 is generally forward of the passenger side of the passenger compartment 16. The vehicle storage assembly 12 can be embodied as a glove box made available for storing items inside of the vehicle 10.

While a glove box is illustrated as the vehicle storage assembly 12, it should be appreciated that the activation and latch mechanism 14 may be employed on other vehicle storage assemblies 12, such as, a center console lid, trunk tub cover, and other compartments. In certain embodiments, the vehicle storage assembly 12 comprises a static part or compartment housing 20 and a moving part or compartment 22. In certain embodiments, the moving part 22 can comprise a door.

In certain embodiments, features of the activation and latch mechanism 14 can include the size and type of materials, gearing between pinion and gear, and characteristics (torque, size, RPM, etc.) of the motor used to automate movement of the compartment. Certain embodiments of the activation and latch mechanism 14 deliver cost and mass reductions, provide a premium level to the passenger compartment 16, and improve the user experience.

In certain embodiments, the compartment 22 comprises a receptacle 29 and an opening 31 to permit access to the receptacle 29. The receptacle 29 can have walls (e.g., sides 33, and bottom 35) that define the shape and size of the receptacle 29.

In certain embodiments, the compartment housing 20 comprises a door which is movable (e.g., pivot) relative to the dash 18 to allow the compartment 22 to linearly slide between the open and closed configurations.

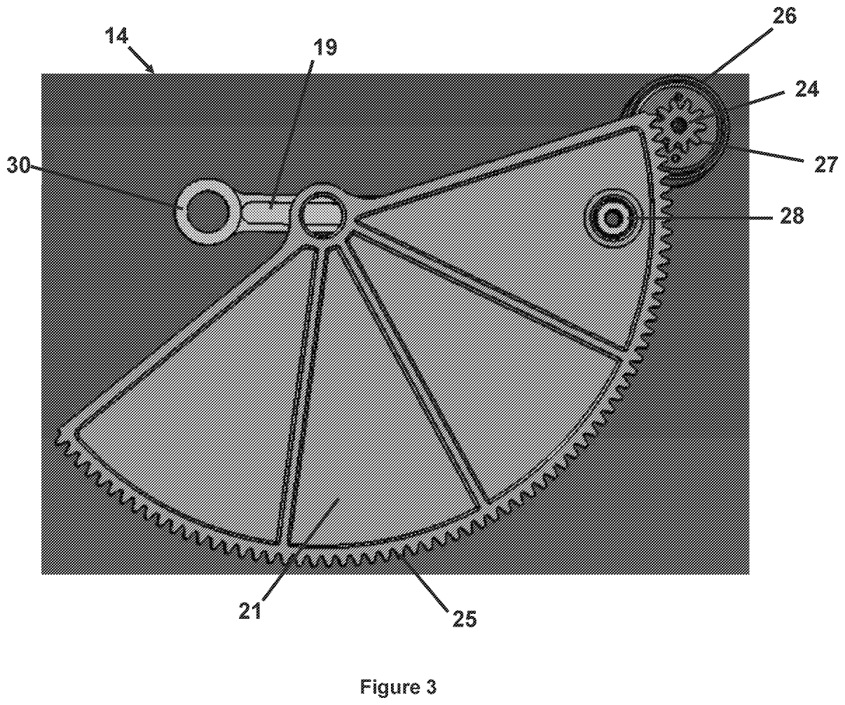

FIG. 3 is a plan view that includes the activation and latch mechanism 14 from FIG. 2A. In certain embodiments, the activation and latch mechanism 14 employs an arm 19 and a gear 21. In certain embodiments, rotational motion of the gear 21 about axis 23 is converted to linear motion of the compartment 22 between the open and closed configurations via the arm 19. In certain embodiments, the arm 19 comprises a distal end 28 and a proximal end 30. In certain embodiments, the distal end 28 is rotationally coupled to the gear 21. In certain embodiments, the proximal end 30 is rotational coupled to the compartment 22.

In certain embodiments, the gear 21 comprises one or more teeth 25 configured to engage with one or more teeth 27 of a pinion 24. In this way, rotation of the pinion 24 is transferred to rotation of the gear 21.

In certain embodiments, the activation and latch mechanism 14 comprises a motor 26. In certain embodiments, the motor 26 is configured to drive rotation of the pinion 24. Depending on the direction of rotation, the pinion 24 causes the compartment 22 to move towards or away from the closed configuration via the gear 21 and the arm 19.

In certain embodiments, when the motor 26 is not activated and the compartment 22 is not in the closed configuration, the gear 21 and pinion 24 will freely rotate if the user moves the compartment 22 (1) towards the closed configuration or (2) away from an almost closed configuration. In certain embodiments, even when the motor 26 is activated and the compartment 22 is not in the closed configuration, the gear 21 and pinion 24 will freely rotate if the user moves the compartment 22 (1) towards the closed configuration or (2) away from an almost closed configuration. In this way, the user is able to manually activate sliding of the compartment 22 regardless of whether the motor 26 is or is not activated. In certain embodiments, the activation and latch mechanism 14 prevents the user from manually opening the compartment 22 from the closed configuration.

In certain embodiments, the arm 19 of the activation and latch mechanism 14 is oriented so as be collinear with a direction of movement for the compartment 22 when the compartment 22 is in the closed configuration which also achieves a latch position 34 preventing the user from manually opening the compartment 22. When in the latch position 34, the compartment 22 cannot be opened manually (e.g., manual activation) by the user but can be opened by automatic activation.

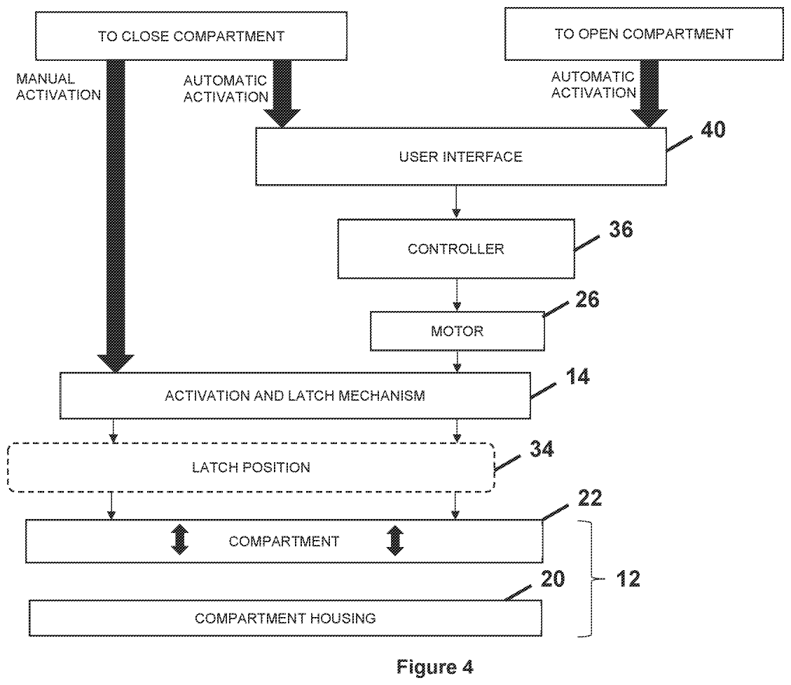

FIG. 4 is a schematic view of the vehicle storage assembly 12 from FIG. 2A that provides both manual activation and automatic activation of the compartment 22 from FIG. 2B. In certain embodiments the vehicle storage assembly 12 comprises a controller 36. In certain embodiments, the controller 36 receives various inputs including a screen tap or input to a display 40 (FIG. 1). In certain embodiments, the controller 36 controls application of electrical current to the motor 26. For example, in certain embodiments, the vehicle storage assembly 12 comprise the motor 26. The motor 26 converts electrical energy into mechanical energy. The controller 36 can energize the motor 26 to cause the rotation of the pinion 24 in either a clockwise direction or a counterclockwise direction. It should be appreciated that other devices, (e.g., key fob), can be employed by the user to provide input signals to the controller 36.

In certain embodiments, the controller 36 determines if the screen 40 has been tapped by the user. If tapped, in certain embodiments, the controller 36 applies current to the motor 26 to open or close the vehicle storage assembly 12. When in the latch position 34, the compartment 22 cannot be opened manually (e.g., manual activation) by the user but can be opened by automatic activation.

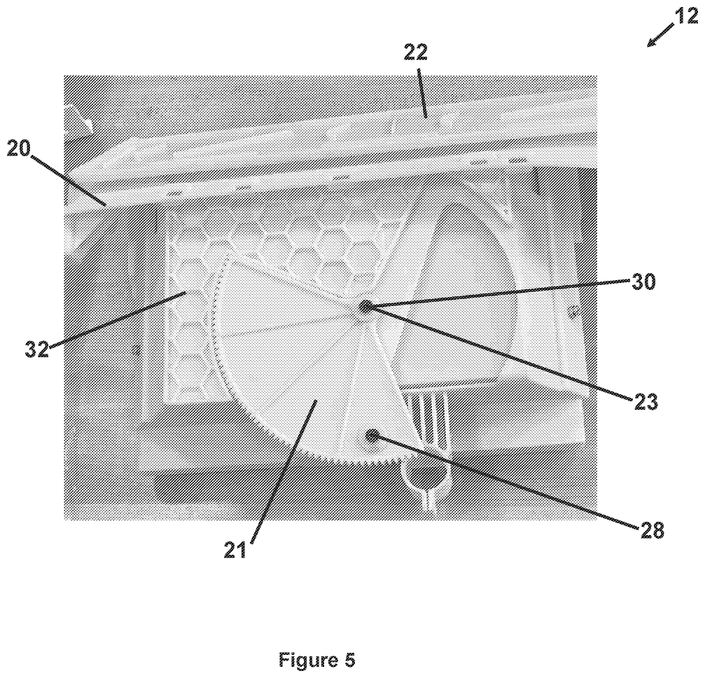

FIG. 5 is a bottom view of the vehicle storage assembly 12 from FIG. 2A showing the activation and latch mechanism 14. In certain embodiments, the vehicle storage assembly 12 comprises a stop plate 32. In certain embodiments, at least a portion of the stop plate 32 is sized and shaped to abut the gear 21 when the compartment 22 is in the closed configuration. In certain embodiments, at least a portion of the stop plate 32 is sized and shaped to abut the gear 21 when the compartment 22 is in the open configuration. For example, as is illustrated in FIG. 5, the compartment 22 is in the closed configuration with the gear 21 abutting the stop plate 32.

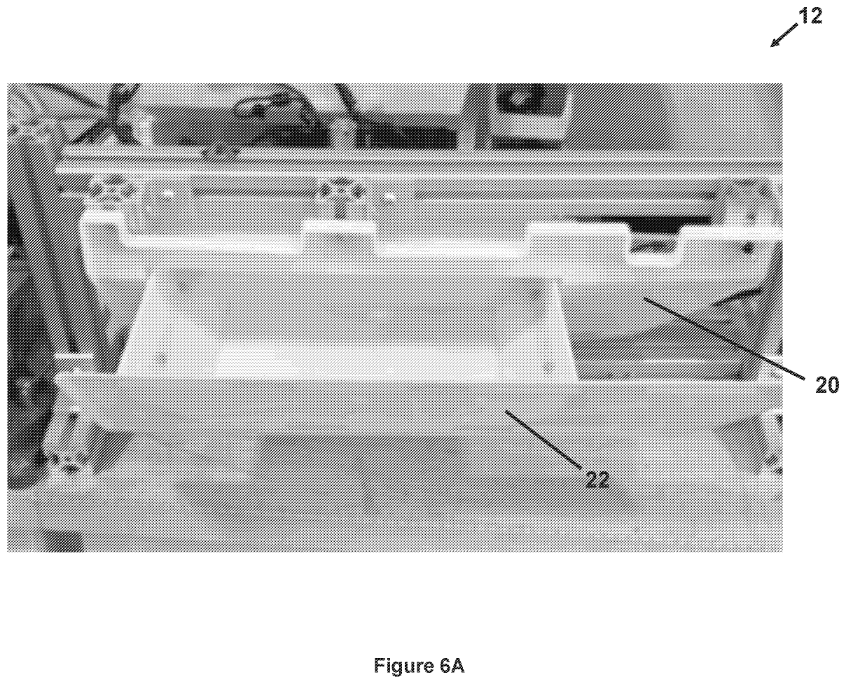

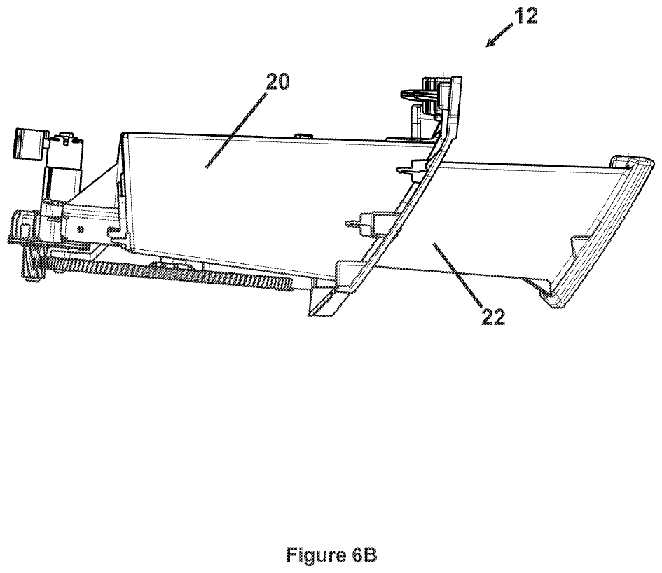

FIG. 6A is a front perspective view of the vehicle storage assembly 12 from FIG. 2A with the compartment 22 linearly slid out of the compartment housing 20 into the open configuration. FIG. 6B is a side view of the vehicle storage assembly 12 from FIG. 2A with the compartment 22 linearly slid out of the compartment housing 20 into the open configuration. The compartment 22 can store vehicle accessories, personal belongings and other objects. For example, vehicles 10 typically include a vehicle storage assembly 12 configured as a glove box. The glove box can be located in the dash 18 on the front passenger side of the passenger compartment 16.

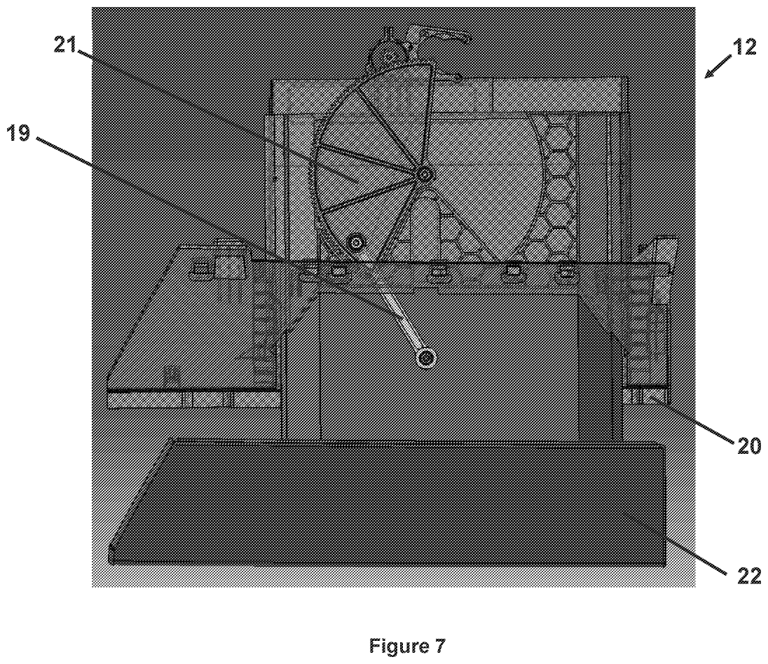

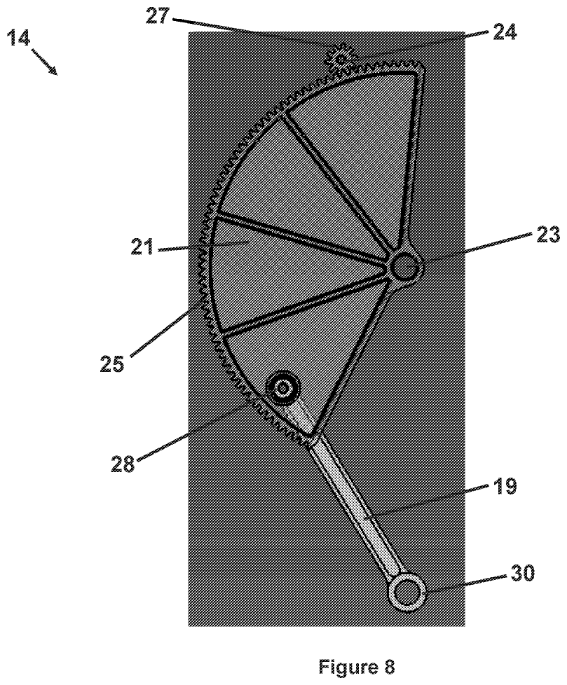

FIG. 7 is a bottom view of the vehicle storage assembly 12 with the arm 19 of the activation and latch mechanism 14 in a first position opening the compartment 22. In the illustrated embodiment, the first position is the open configuration. FIG. 8 shows the arm 19 and the gear 21 from FIG. 7 when the arm 19 is in the first position. In the illustrated embodiment, the compartment 22 has been slid in a linear direction away from the compartment housing 22 allowing the user to access an interior of the compartment 22.

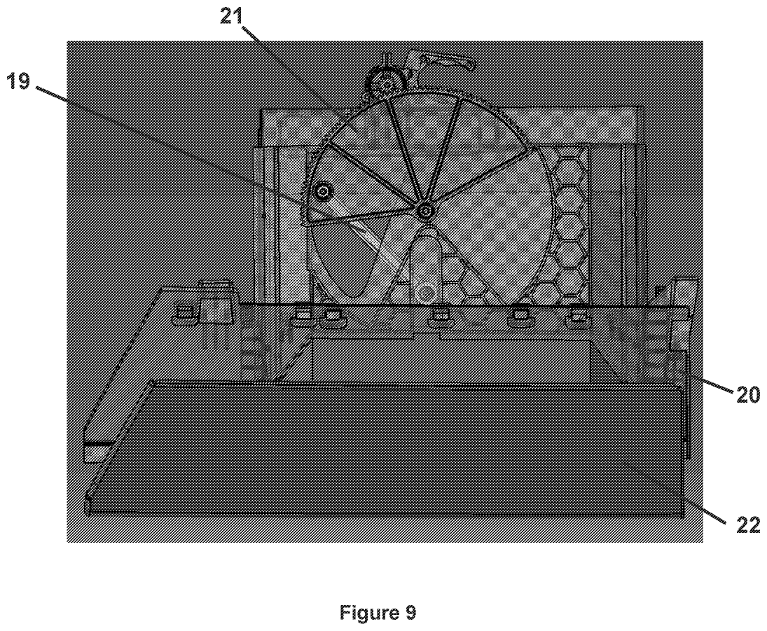

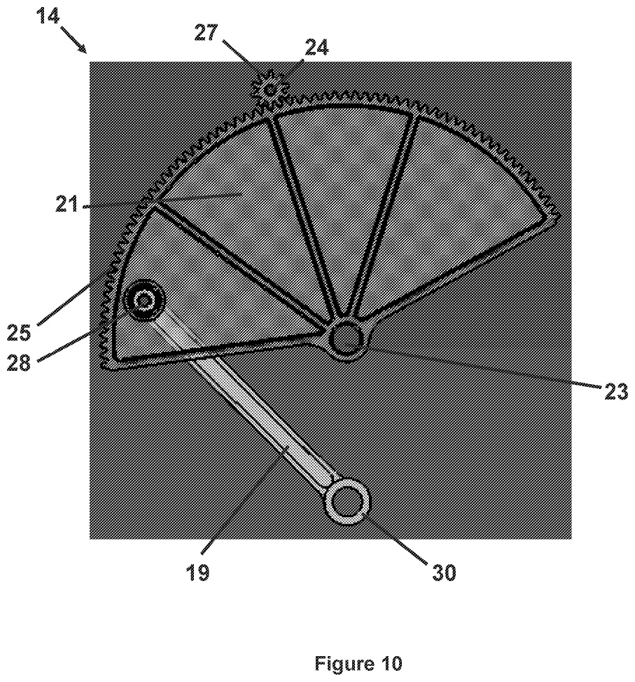

FIG. 9 is similar to FIG. 7 except the arm 19 has moved to a second position partially closing the compartment 22. In the illustrated embodiment, the second position is a position between the open configuration and the closed configuration. FIG. 10 shows the arm 19 and the gear 21 from FIG. 9 when the arm 19 is in the second position. In the illustrated embodiment, the compartment 22 has been slid in a linear direction towards the compartment housing 22 but not all the way to the closed configuration.

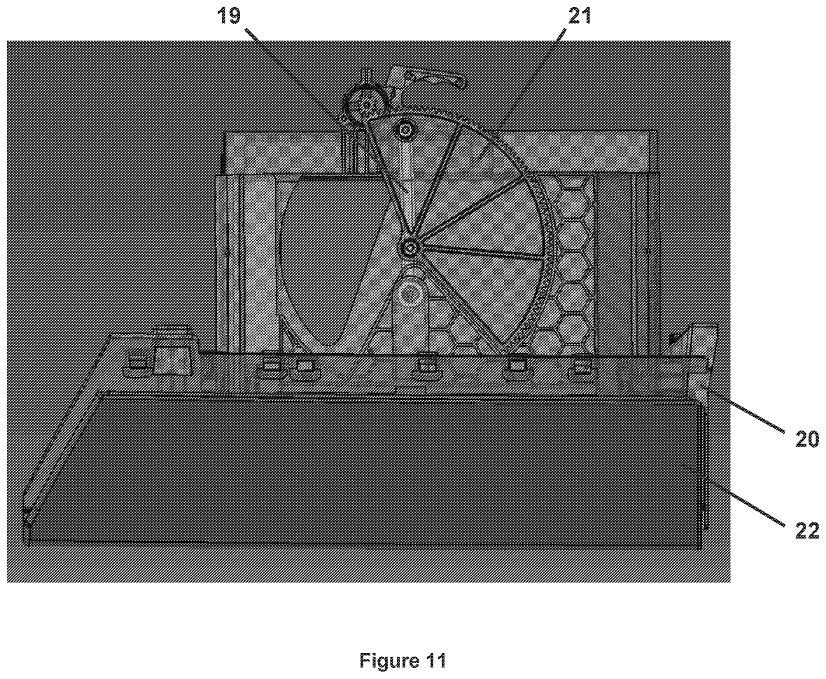

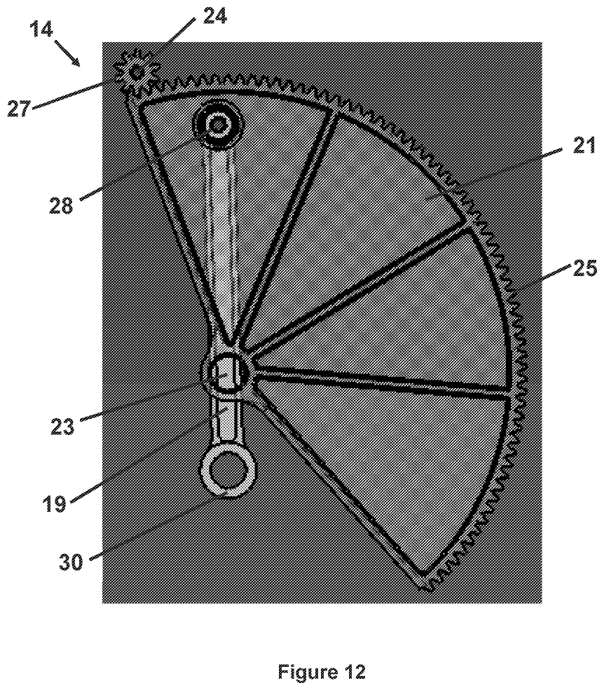

FIG. 11 is similar to FIG. 9 except the arm 19 has moved to a third position closing the compartment 22 in a latch position 34. FIG. 12 shows the arm 19 and the gear 21 from FIG. 11 when the arm 19 is in the third position inhibiting the compartment 22 from being manually opened. In the illustrated embodiment, the third position is the closed configuration. As is illustrated in FIG. 11, the arm 19 of the activation and latch mechanism 14 is oriented so as be collinear with a direction of movement for the compartment 22 when the compartment 22 is in the closed configuration. Such an arrangement achieves the latch position 34 which prevents the user from manually opening the compartment 22. In this way, in certain embodiments, the arm 19 inhibits or prevents opening of the compartment 22 meeting the safety requirements for Federal Motor Vehicle Safety Standard 206: Door locks and door retention components and SAE J839B: Passenger Car Side Door Latch System.

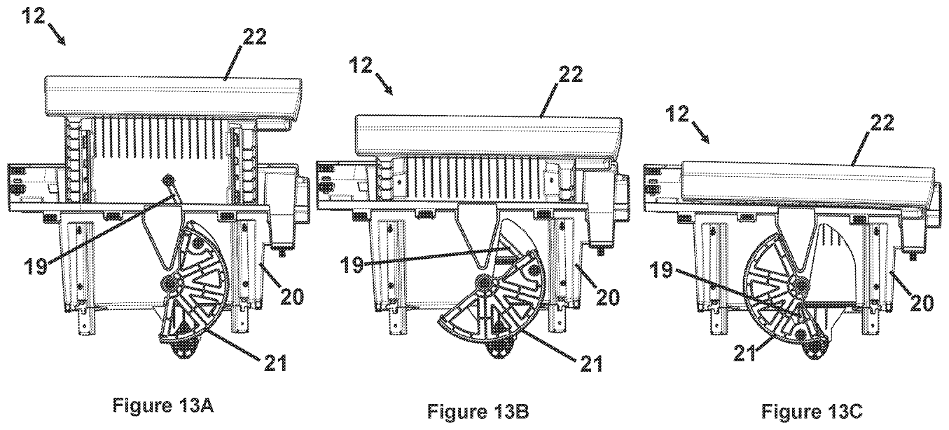

FIG. 13A is a bottom view of the vehicle storage assembly 12 with the arm 19 of the activation and latch mechanism 14 in the first position opening the compartment 22. FIG. 13B is similar to FIG. 13A except the arm 19 has moved to the second position partially closing the compartment 22. FIG. 13C is similar to FIG. 13B except the arm 19 has moved to the third position closing the compartment 22 in the latch position 34.

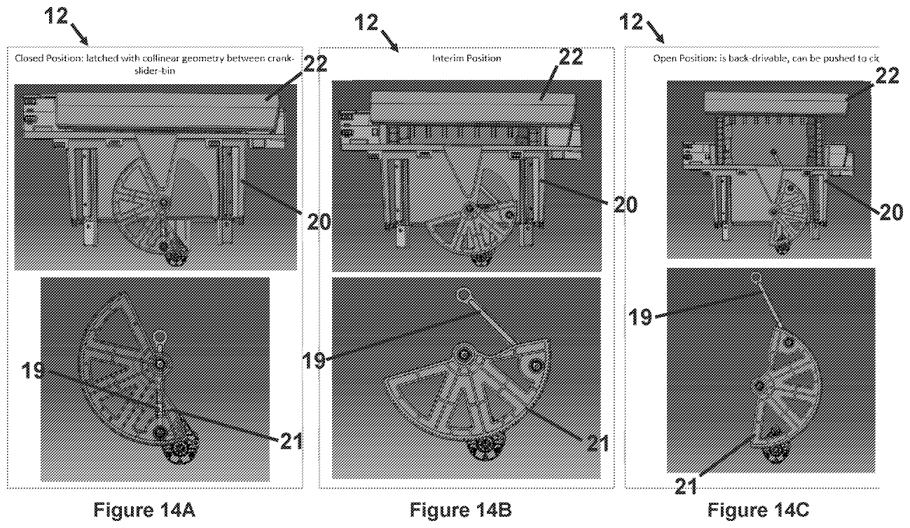

FIG. 14A are bottom views of the vehicle storage assembly 12 with the arm 19 in the third position closing the compartment 22 in the latch position 34. An isolated view of the arm 19 and gear 21 is also illustrated. For example, in the closed position the vehicle storage assembly 12 is latched with collinear geometry between crank-slider-bin. FIG. 14B is similar to FIG. 14A except the arm 19 has moved to the second position partially opening the compartment 22. For example, the vehicle storage assembly 12 is in an interim position. FIG. 14C is similar to FIG. 14B except the arm 19 of the activation and latch mechanism 14 has moved to the first position opening the compartment 22. For example, in the open position the compartment 22 is back-drivable and can be pushed to close.

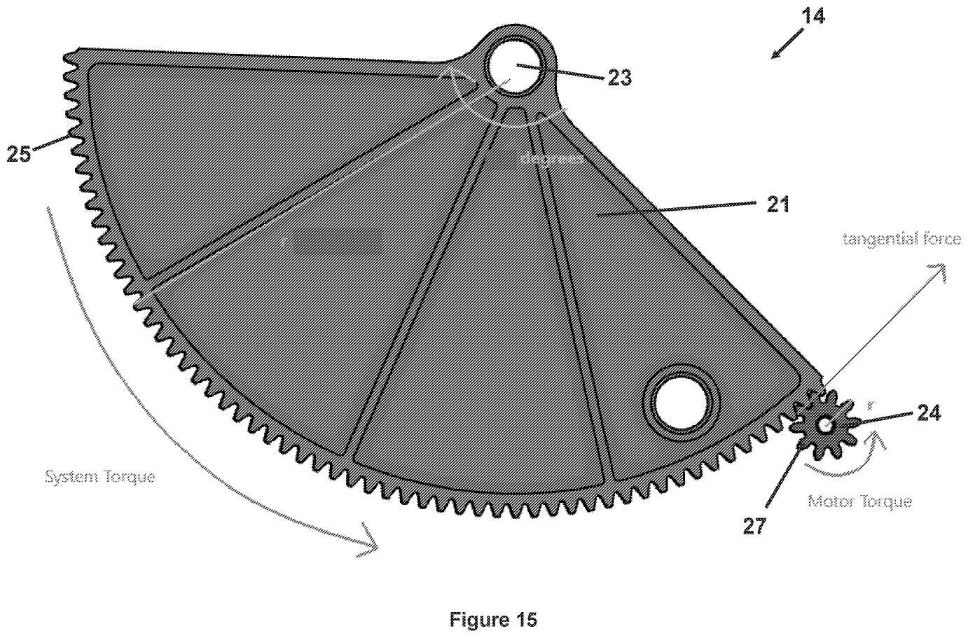

FIG. 15 is a plan view that includes the gear 21 and the pinion 24 from FIG. 3. In certain embodiments, the gear 21 comprises one or more teeth 25 configured to engage with one or more teeth 27 of a pinion 24. In this way, rotation of the pinion 24 is transferred to rotation of the gear 21. In certain embodiments, rotational motion of the gear 21 about axis 23 is converted to linear motion of the compartment 22 between the open and closed configurations.

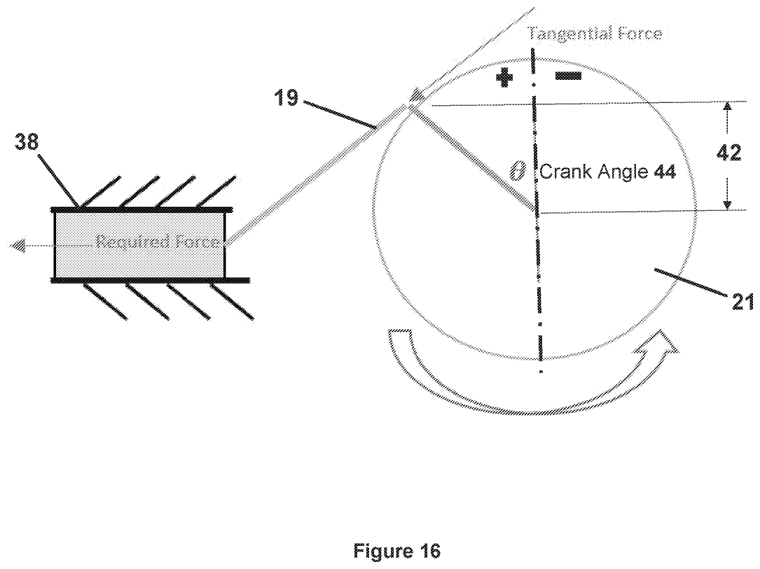

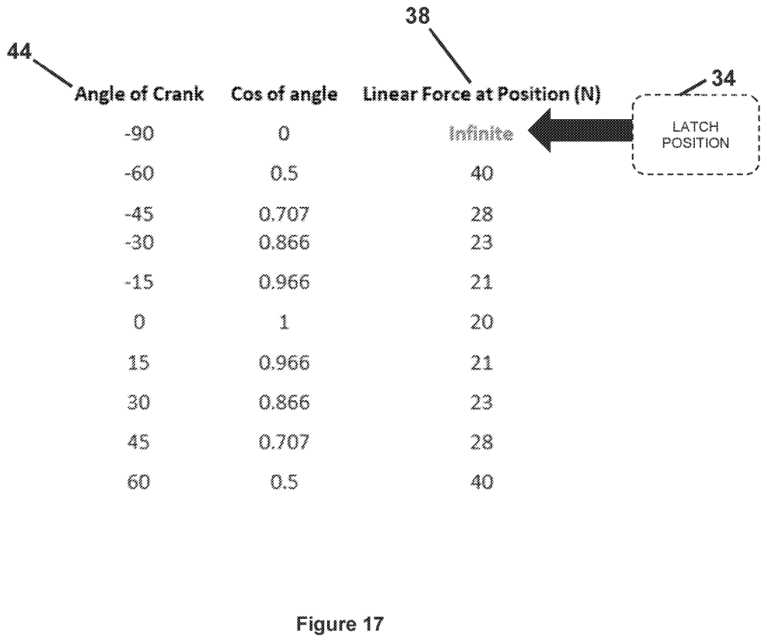

FIG. 16 illustrates how a moment arm 42 for applying to a force 38 to open the compartment 22 varies depending on a crank angle 44 of the arm 19. FIG. 17 illustrates exemplary values for the force 38 required to open the compartment 22 depending on the crank angle 44 of the arm 19 from FIG. 16. As is shown in FIG. 17, the force 38 required to move the compartment 22 from the closed configuration to the open configuration when the crank angle 44 is 90° reaches an infinite value preventing opening of the compartment 22 (e.g., satisfy safety standards). In this way, in certain embodiments, the activation and latch mechanism 14 inhibits or prevents opening of the compartment 22 meeting the safety requirements for Federal Motor Vehicle Safety Standard 206: Door locks and door retention components and SAE J839B: Passenger Car Side Door Latch System without the need for a dedicated latching mechanism.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed activation and latch mechanism. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A vehicle storage assembly comprising:
a compartment housing having an opening;
a compartment proximate to the opening and configured to move between an open configuration and a closed configuration;
a controller configured to receive an input signal and automate movement of the compartment between the open configuration and the closed configuration; and an activation and latch mechanism coupled to the compartment and configured for a user to manually move the compartment to the closed configuration, wherein the manual movement of the compartment by the user towards the closed configuration latches the compartment in a latch position when the compartment reaches the closed configuration.

2. The storage assembly of claim 1, wherein the input signal is received from one or more of a display, a key fob, a button, and a switch.

3. The storage assembly of claim 1, wherein the compartment is configured as a drawer of a glove box.

4. The storage assembly of claim 3, wherein the compartment housing is sized and shaped to receive the drawer of the glove box.

5. The storage assembly of claim 1, wherein the automated movement is linear movement of the compartment relative to the compartment housing.

6. The storage assembly of claim 1, wherein the manual movement is linear movement of the compartment relative to the compartment housing.

7. The storage assembly of claim 1, wherein the activation and latch mechanism comprises an arm and a gear, and wherein the arm couples the compartment to the gear.

8. The storage assembly of claim 7, wherein the arm converts linear motion of the compartment caused by the user manually moving the compartment towards the closed configuration to rotational motion of the gear.

9. The storage assembly of claim 7, further comprising a motor configured to cause the automated movement of the compartment between the open configuration and the closed configuration.

10. The storage assembly of claim 9, further comprising a pinion coupled to the gear and the motor.

11. The storage assembly of claim 7, wherein the latch position occurs when the arm is oriented so as be collinear with a direction of the manual movement and the compartment is in the closed configuration.

12. The storage assembly of claim 1, wherein when the compartment is in the latch position, the activation and latch mechanism prevents the user from manually moving the compartment to the open configuration.

13. The storage assembly of claim 12, wherein when the compartment is in the latch position, the activation and latch mechanism allows the controller to automate movement of the compartment to the open configuration.

14. The storage assembly of claim 1, further comprising a display configured to receive the input signal, the compartment moving between the open configuration and the closed configuration in response at least in part to the input signal.

15. The storage assembly of claim 14, wherein the input signal is a screen tap on the display.

16. The storage assembly of claim 14, wherein the display is disposed remote from the activation and latch mechanism.

17. The storage assembly of claim 1, wherein the compartment housing comprises a door, and wherein the door is a trim panel.

18. The storage assembly of claim 17, wherein the compartment is disposed behind the trim panel at least when in the closed configuration.

19-25. (canceled)

25. An activation and latch mechanism for a vehicle that allows automated movement of a compartment between an open configuration and a closed configuration while also allowing manual movement of the compartment from the open configuration towards the closed configuration and preventing the manual movement of the compartment from the closed configuration towards the open configuration, wherein the compartment is in a latch position when the compartment reaches the closed configuration.

26-43. (canceled)

44. A method of closing a compartment housing having an opening, a compartment being proximate to the opening and movable between an open configuration and a closed configuration, the method comprising:
receiving an input signal to automate movement of the compartment between the closed configuration and the open configuration;
moving the compartment by automation to the open configuration based on the input signal; and
manually moving the compartment from the open configuration to the closed configuration so as to latch the compartment in the closed configuration.

45-49. (canceled)
